(19) United States
(12) Patent Application Publication
(10) Pub. No.: US 2016/0304330 A1
(43) Pub. Date: Oct. 20, 2016

(54) Bottle and jar lid opener

(71) Applicant: Henri Claude Cardinal, St-Mathieu de Laprairie (CA)

(72) Inventor: Henri Claude Cardinal, St-Mathieu de Laprairie (CA)

(21) Appl. No.: 15/068,724

(22) Filed: Mar. 14, 2016

(30) Foreign Application Priority Data
Apr. 18, 2015 (GB) 1506596.4

(51) Int. Cl. B67B 7/44; B67B 7/16; B67B 7/14

(52) U.S. Cl. CPC B67B 7/44; B67B 7/14; B67B 7/16

(57) ABSTRACT

A bottle and jar lid opener takes the form of a V-shaped plate having a top side and a bottom side. The top is affixed to a cabinet's underside via mechanical fasteners driven through holes; a gripping surface located in an interior portion of a V-shaped opening; a drop down blade optimized for opening plastic packaging; a bottle opener, and a can opener attachment, all located on the bottom side of the gripping surface.

### FIELD OF THE INVENTION

The present invention relates generally to a lid opener but more particularly to a fixed lid opener for jars and bottles of varying sizes.

### BACKGROUND OF THE INVENTION

Opening jars and bottles with tight lids have posed a challenge for decades. Oftentimes an individual's two hands are not enough as one hand is required to hold the jar while the other twists the lid. Two people are therefore required for tight jars where one holds the bottle while the other tries the lid. There hence exists a need for a lid opener which allows an individual to open a jar or bottle by themselves using both hands to hold the bottle or lid.

### SUMMARY OF THE INVENTION

In view of the foregoing disadvantages inherent in the known devices now present in the prior art, the present invention, which will be described subsequently in greater detail, is to provide objects and advantages which are:

To provide for a a fixed V-shaped jar and bottle lid opener that allows a user to hold the jar or bottle firmly with both hands while twisting open.

It is another advantage of this invention that the V-shaped lid opener be affixed via screws under a cabinet, bar counter, overhang wall or similar

It is a further advantage of this invention that the invention is able to open lids of various sizes from 4 inches in diameter to smaller and is coated in a gripping material such as neoprene, rubber, silicone or similar to provide a firm grip on lids while opening.

In order to do so, the invention takes the form of a V-shaped plate having a top side and a bottom side. The top is affixed to a cabinet's underside via mechanical fasteners driven through holes; a gripping surface located in an interior portion of a V-shaped opening; a drop down blade optimized for opening plastic packaging; a bottle opener, and a can opener attachment, all located on the bottom side of the gripping surface.

The drop down blade is designed to be pushed down when in use and pushed up when not in use.

There is a recessed opening to accommodate a can opener with a magnet for opening metal cans.

There is a base plate between the cabinet and the lid opener such that the cabinet is not scratched or worn with use.

The inside of the V-shaped opening is provided with a coating, of materials taken from the list of, but not limited to neoprene tape, silicone, rubber or other suitable material having good gripping characteristics.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIG. 1 Isometric view of the invention.

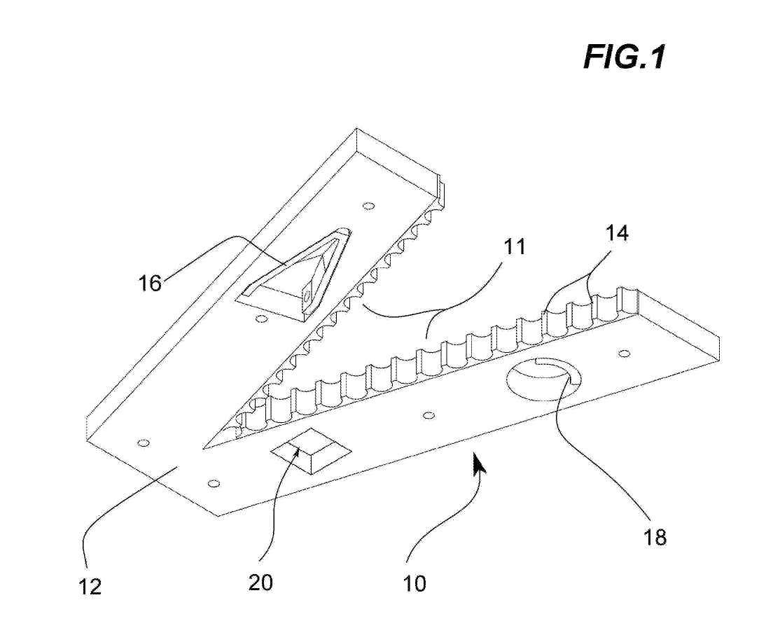

FIG. 2 Isometric view of the invention with an accessory extended.

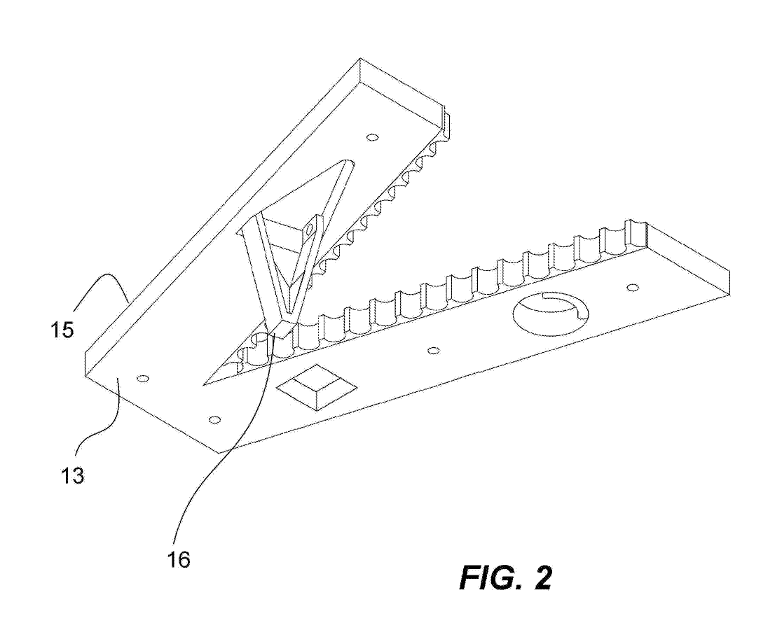

FIG. 3 View of invention fixed under a cabinet.

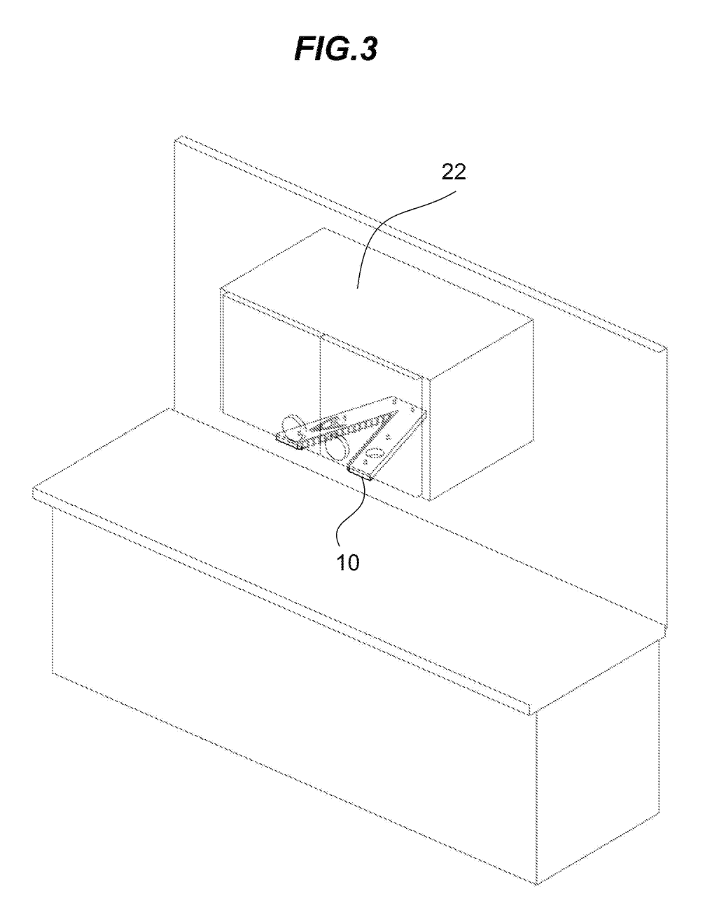

FIG. 4 Isometric view of invention, base plate and screws.

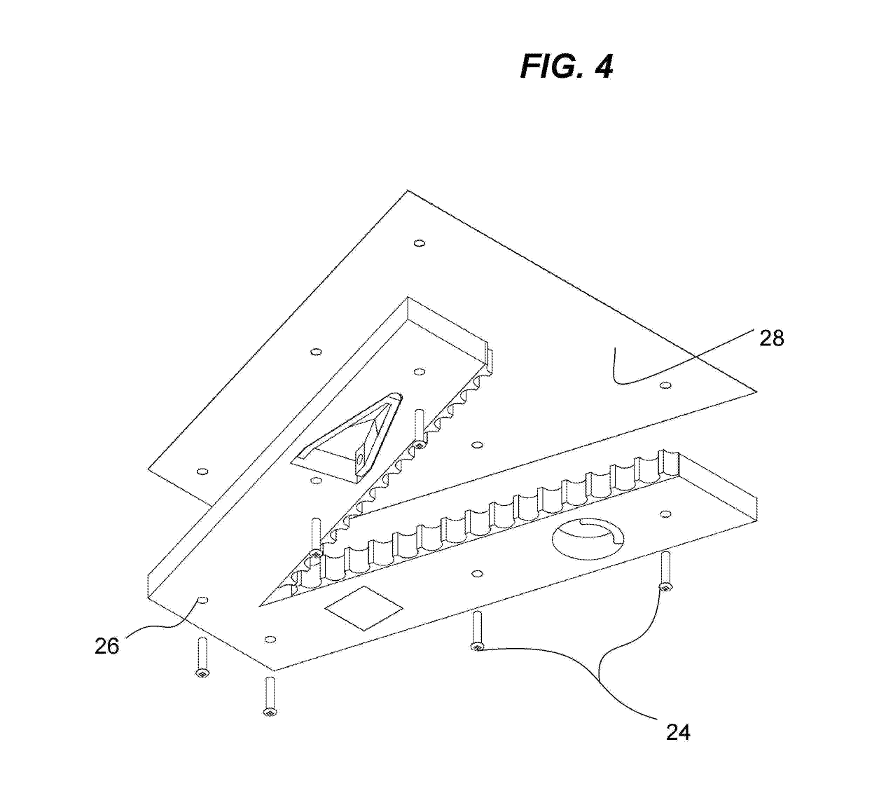

FIGS. 5a-b Isometric view of invention in use.

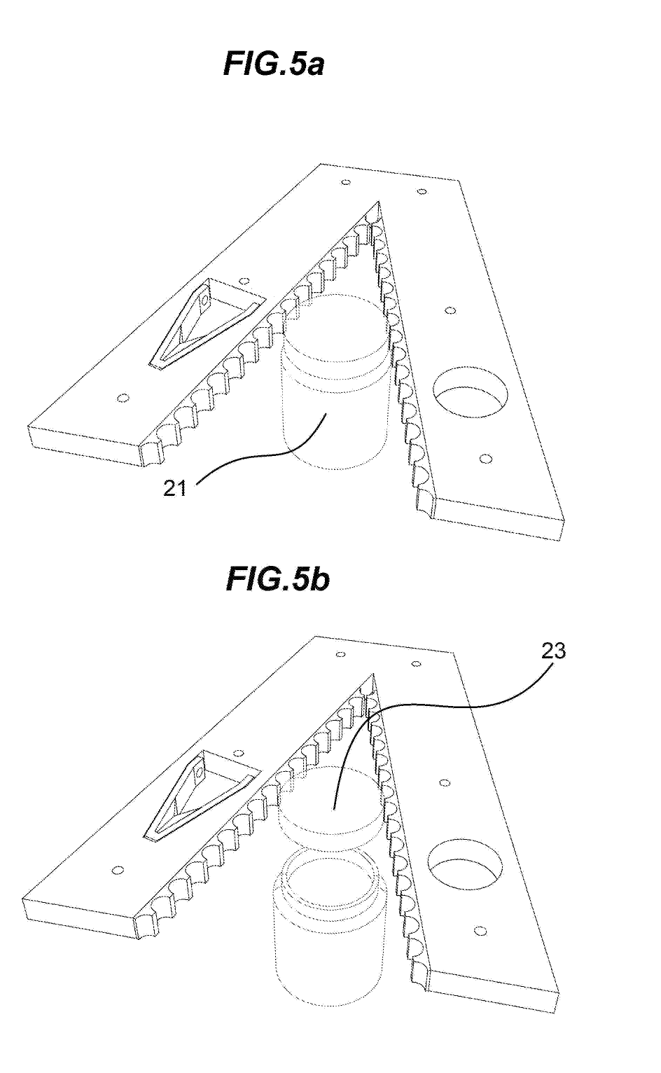

FIGS. 6-a-b-c-d-e-f Rear, top, side, bottom, side and front views of the invention.

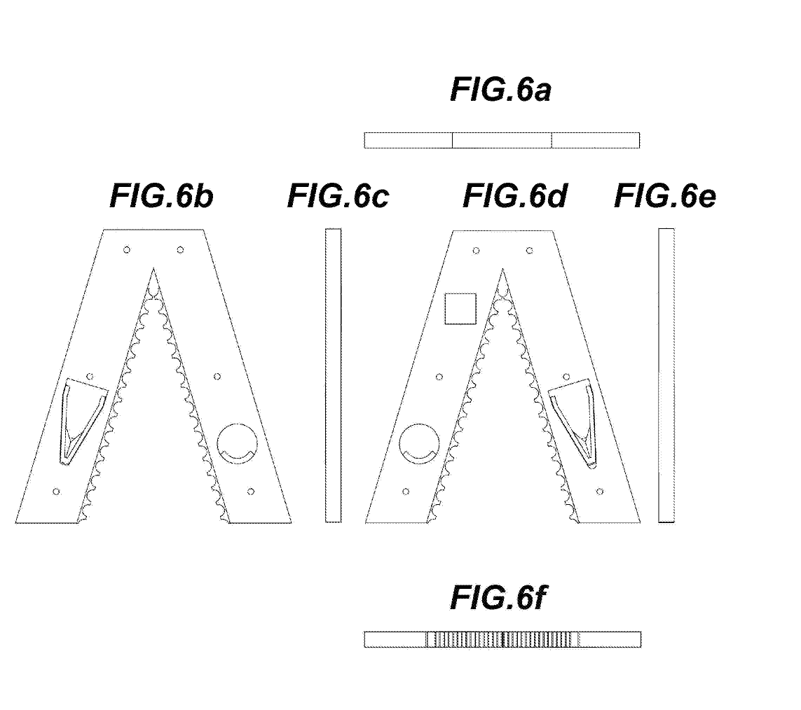

### DETAILED DESCRIPTION

A lid opener (10) comprising of a V-shaped plate (12) having a gripping surface (14) on the inside of the V-shaped opening (11), a drop down blade (16) for opening plastic packaging (not shown), a bottle opener (18) and a provision (20) for attaching a can opener (not shown) provided on its bottom side (13). The top side (15) is affixed to an underside portion of a cabinet (22) via mechanical fasteners (24), such as screws, for example, and can be pushed up into place and pulled down when needed. A jar (21) is inserted firmly into the V-shaped opening (11) and the jar (21) is twisted in a clockwise direction to open its lid (23). Similarly jars (21) and bottles (not shown) of varying sizes can be inserted into the V-shaped opening (11) until it is gripped firmly by the gripping surface (14) provided, and then twisted to open the jar (21) or bottle (not shown).

The V-Shaped plate (12) is about ½ inch thick, each arm of the V are approximately 2 inches wide and an opening that is 9 inches wide at the ends of the V, 3¼ inches at the beginning of the V and 10 inches in length. The inside of the “V” is provided with a coating, such as neoprene tape, silicone, rubber or other suitable material having good gripping characteristics.

A recessed opening (20) can accommodate a can opener with a magnet (not shown) for opening metal cans. The lid opener (10) can be attached directly to a cabinet (22) or alternatively using a base plate (28) between the cabinet (22) and lid opener (10) such that the cabinet (22) is not scratched or worn with use.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A lid opener comprising a V-shaped plate having a top side and a bottom side; said top side being affixed to a cabinet's underside via mechanical fasteners driven through holes; a gripping surface located in an interior portion of a V-shaped opening; a drop down blade optimized for opening plastic packaging; a bottle opener, and a can opener attachment, all located on the bottom side of said gripping surface.

2. A lid opener as in claim 1 wherein said drop down blade is designed to be pushed down when in use and pushed up when not in use.

3. A lid opener as in claim 1 wherein there is a recessed opening to accommodate a can opener with a magnet for opening metal cans.

4. A lid opener as in claim 1 wherein there is a base plate between said cabinet and said lid opener such that said cabinet is not scratched or worn with use.

5. A lid opener as in claim 1 wherein said V-Shaped plate measures ½ inch thick, each arm of said V-shaped plate are 2 inches wide, with an opening that is 9 inches wide at the ends of said V-shaped plate; 3¼ inches at the beginning of said V-shaped plate; and 10 inches in length.

6. A lid opener as in claim 1 wherein said inside of said V-shaped opening is provided with a coating, of materials taken from the list of, but not limited to neoprene tape, silicone, rubber or other suitable material having good gripping characteristics.
